(19) United States
(12) Patent Application Publication
(10) Pub. No.: US 2022/0342848 A1
(43) Pub. Date: Oct. 27, 2022

(54) SNAPSHOT SPACE REPORTING USING A PROBABILISTIC DATA STRUCTURE

(71) Applicant: VMware, Inc., Palo Alto, CA (US)

(72) Inventors: Pranay Singh, Palo Alto, CA (US); Wenguang Wang, Palo Alto, CA (US); Nitin Rastogi, Palo Alto, CA (US)

(73) Assignee: VMware, Inc., Palo Alto, CA (US)

(21) Appl. No.: 17/239,239

(22) Filed: Apr. 23, 2021

(51) Int. Cl. G06F 16/11; G06F 9/455; G06F 16/13; G06F 16/188; G06N 7/00

(52) U.S. Cl. CPC G06F 16/128; G06F 9/45558; G06F 16/137; G06F 16/188; G06N 7/005; G06F 2009/45583; G06F 2009/45562

(57) ABSTRACT

The present disclosure is related to methods, systems, and machine-readable media for snapshot space reporting. A first probabilistic data structure can be created for a first snapshot of a virtual computing instance (VCI) in a file system based on a hash of physical block numbers of a plurality of blocks of the first snapshot. A second probabilistic data structure can be created for a second snapshot of the VCI based on a hash of physical block numbers of a plurality of blocks of the second snapshot. A space report can be determined for the first and second snapshots based on the first probabilistic data structure and the second probabilistic data structure, wherein the space report is indicative of the storage space occupied by the first and second snapshots. A file system function can be performed by reference to the space report.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may purchase data storage and/or data processing services from the provider in order to run applications that handle the enterprises' core business and operational data. The applications may be proprietary and used exclusively by the enterprise or made available through a network for anyone to access and use.

Virtual computing instances (VCIs) have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

Snapshots may be utilized in a software defined data center to provide backups and/or disaster recovery. For instance, a snapshot can be used to revert to a previous version or state of a VCI. Snapshots may utilize a copy-on-write policy that involves sharing storage, which, while being space efficient, makes space reporting problematic. Some previous approaches utilize counters to keep track of space. These approaches face high input/output overhead because the reference count(s) of block(s) can change frequently.

### BRIEF DESCRIPTION OF THE DRAWINGS

FIG. 1 is a diagram of a host and a system for snapshot space reporting according to one or more embodiments of the present disclosure.

FIG. 2A illustrates an example file system B-tree according to one or more embodiments of the present disclosure at a first time instance.

FIG. 2B illustrates the example file system B-tree at a second time instance.

FIG. 3 illustrates an example of HyperLogLog according to one or more embodiments of the present disclosure.

FIG. 4 is a Venn diagram illustrating the physical space represented by three snapshots according to one or more embodiments of the present disclosure.

FIG. 5 is a diagram of a system for snapshot space reporting according to one or more embodiments of the present disclosure.

FIG. 6 is a diagram of a machine for snapshot space reporting according to one or more embodiments of the present disclosure.

FIG. 7 is a flow chart illustrating one or more methods for snapshot space reporting according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

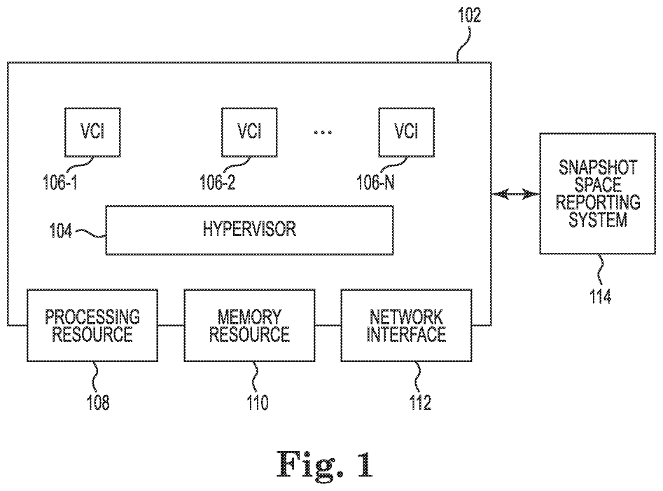

As used herein with respect to VCIs, a “disk” is a representation of memory resources (e.g., memory resources 110 illustrated in FIG. 1) that are used by a VCI. As used herein, “memory resource” includes primary storage (e.g., cache memory, registers, and/or main memory such as random access memory (RAM)) and secondary or other storage (e.g., mass storage such as hard drives, solid state drives, removable media, etc., which may include non-volatile memory). The term “disk” does not imply a single physical memory device. Rather, “disk” implies a portion of memory resources that are being used by a VCI, regardless of how many physical devices provide the memory resources.

A VCI snapshot (referred to herein simply as “snapshot”) is a copy of a disk file of a VCI at a given point in time. A snapshot can preserve the state of a VCI so that it can be reverted to at a later point in time. The snapshot can include memory as well. In some embodiments, a snapshot includes secondary storage, while primary storage is optionally included with the snapshot. A snapshot can store changes from a parent snapshot (e.g., without storing an entire copy of the parent snapshot). A snapshot includes one or more extents. An extent is a contiguous area of storage reserved for a file in a file system. An extent can be represented, for instance, as a range of block numbers. Stated differently, an extent can include one or more data blocks that store data. Snapshots provide filesystems the ability to take an instantaneous copy of the filesystem. An instantaneous copy allows the restoration of older versions of a file or directory from an accidental deletion, for instance. Snapshots also provide the foundation for other disaster recovery features, such as backup applications and/or snapshot-based replication.

An administrator may desire to determine the storage capacity or space occupied by one or more snapshots. Previous means of space reporting make queries about a group of snapshots expensive. For instance, as previously discussed, snapshots may utilize a copy-on-write policy that involves sharing storage, which, while being space efficient, makes space reporting problematic. Some previous approaches utilize counters to keep track of space used by snapshots. These approaches face high input/output overhead because the reference count(s) of block(s) can change frequently. Additionally, such approaches may lack accuracy as the counters, if not properly adjusted, can report the wrong space usage. Other approaches employ a mark and sweep algorithm to determine space usage of snapshots, which carries with it an overhead of performing extra input/output operation(s) and additional memory overhead to track space usage.

In a shared storage setup, such as storage that supports deduplication or in Copy-on-Write (CoW)-based snapshots, space reporting may be difficult. For instance, space reporting in a shared storage setup includes reporting both shared (e.g., common) blocks and exclusively owned blocks. In addition, an operation like snapshot deletion can cause block ownership to change. For instance, the blocks shared between snapshots prior to snapshot deletion can become exclusively owned after snapshot deletion, so the space reporting of snapshots dynamically changes, which is unlike traditional space reporting of snapshots where storage is not shared. Replication or archiving solutions that utilize snapshots may need to determine the similarity of data between a local snapshot and a remote snapshot in order to determine the time involved to replicate or transfer data. Determining the similarity of data is also helpful in data placement in a cloud environment or to a remote node, to get more storage space saving with deduplication. Such problems can be categorized as cardinality estimation problems and similarity problems. Cardinality problems refer to counting the number of unique blocks in a snapshot or in a set of snapshots. Similarity problems refer to determining how snapshots located in a local machine or a remote machine are similar, and therefore the extent to which those snapshots share data blocks.

Embodiments of the present disclosure utilize a probabilistic data structure to enable space reporting of snapshots in a shared storage setup. By so doing, embodiments herein utilize a relatively small amount of memory compared to the size of the actual dataset and incur a reduced computational cost compared with previous approaches. The probabilistic data structure, discussed further below, is referred to herein as a “data sketch.” A respective data sketch can be maintained for each snapshot. In some embodiments, data sketches are based on hyperloglog and can estimate cardinalities (e.g., counts of distinct elements) to a large quantity (e.g., beyond 10⁹) with a reduced error rate (e.g., 1%-2%) while using a relatively small amount of memory (e.g., 1.5 kilobytes). Accordingly, embodiments herein can improve the functioning of a computing device in a virtualized environment by providing space reporting in a less computationally expensive manner than previous approaches.

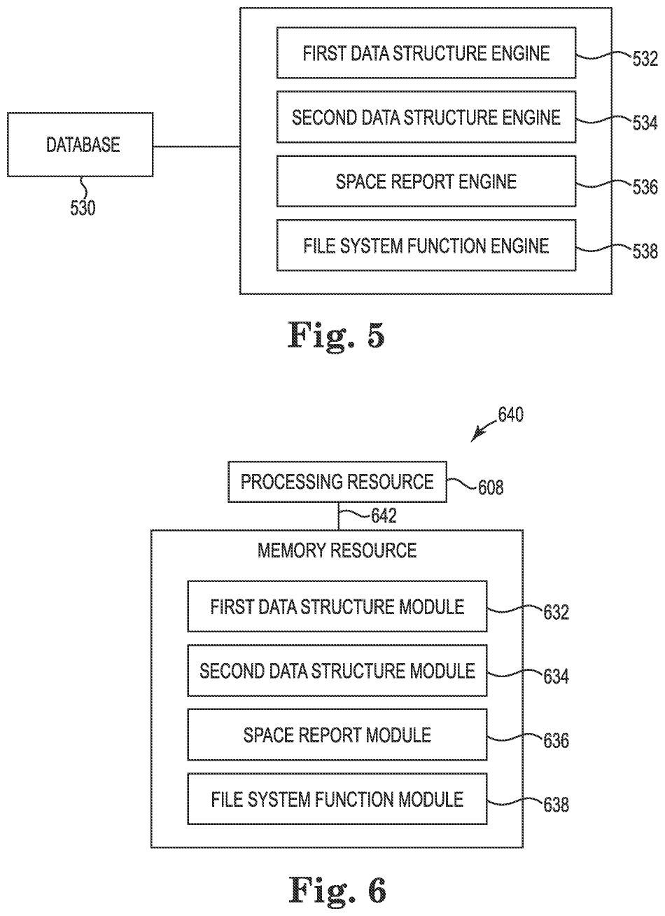

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

FIG. 1 is a diagram of a host and a system snapshot space reporting according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with a snapshot space reporting system 114. An example of the snapshot space reporting system is illustrated and described in more detail below. In some embodiments, the snapshot space reporting system 114 can be a server, such as a web server.

A Virtual Distributed File System (VDFS) is a hyper converged distributed file system. VDFS provides the ability to take a snapshot of a file share by using a CoW B-tree. A snapshot can be considered a copy of a file-share (sub-volume) as it preserves data and metadata for the entire file-share, so one can create a point in time read-only image of the file system. Many sub-volumes can be created in a single VDFS volume. Each snapshot of a sub-volume shares extents (e.g., data blocks) and metadata with other snapshots of the same sub-volume. The sharing of extents and metadata makes snapshots in VDFS space efficient. Blocks that are shared between two or more snapshots can be said to be “common” to those two or more snapshots.

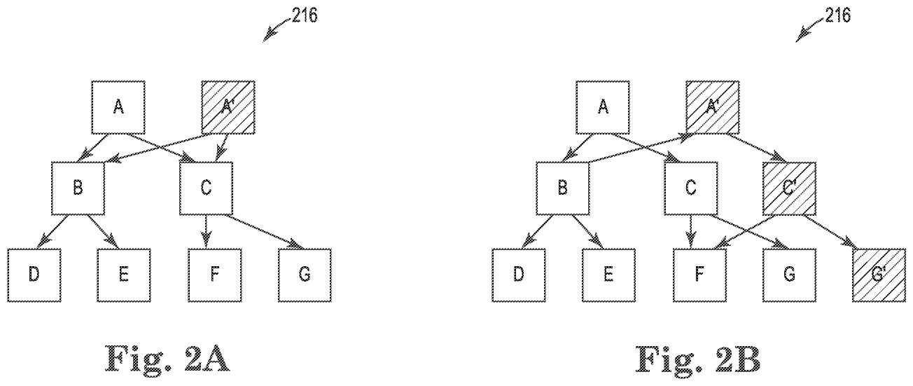

FIG. 2A illustrates an example file system B-tree 216 according to one or more embodiments of the present disclosure at a first time instance. FIG. 2B illustrates the example file system B-tree 216 at a second time instance. FIGS. 2A and 2B may be cumulatively referred to herein as “FIG. 2.” As shown in FIG. 2, the B-tree 216 includes an old root node A and new root node A′. The latest version of the file system (e.g., new writes) would point to root node A′, whereas the older root node A would be pointed to by snapshot. A live sub-volume represents the share of the file system where files are created and deleted, whereas snapshots are accessed via a special directory “/.vdfs/snapshot”. As new writes happen to the live sub-volume, the two B-trees start to differ. Thus, as shown in FIG. 2B, nodes C′ and G′ have been added as child nodes of root node A′. Snapshots and the live sub-volume can share space, but the extent of sharing depends on workload. In order for an administrator to manage space usage of snapshots, he or she may seek to determine answers to questions such as how much space would be freed if a specific snapshot were deleted, how much space would be freed if a subset of snapshots were deleted, and/or how much space would be freed if a sub-volume and all its snapshots were deleted. In many cases, an approximate answer to any or all of these questions is acceptable. Embodiments of the present disclosure include data sketches that provide such answers in a near real-time manner.

Cardinality estimation (a count of distinct elements) can be used in data streaming application, which uses probabilistic data structures called sketches. HyperLogLog (HLL) is a probabilistic data structure that can be used for cardinality estimation in various embodiments. Data sketches, as referred to herein, represent extremely large sets with sub-logarithmic or even constant space complexity. HLL can be used to create a data sketch. For instance, HLL can be used to determine the distinct elements in a multiset. As will be appreciated, HLL can estimate more than 10⁹ cardinalities with a typical accuracy of 2% using 1.5 kilobytes of memory. The operation of HLL is based on the observation that the cardinality of a multiset of uniformly distributed random numbers can be estimated by calculating the maximum number of leading zeros in the binary representation of each number in the set. The effect of high variance is minimized by grouping the numbers and taking the harmonic mean. The algorithm overestimate can be corrected by multiplying with a factor αₘ. The following steps can be used in HLL to find cardinality:

Each entry that is counted is represented in binary by the hash function, h(o)=p⊕q, where p is a prefix and q is a suffix. p is offset into an 8-bit register.

The leftmost 1 bit or a number of leading zero counts is stored to track maximum.

Cardinality is estimated based on formula E=αₘ*m²*Z, wherein m is the number of registers, am corrective factor is 0.7213/(1+1.079/m), Mj is the 1+maximum leading zero count in register j, and Z is a harmonic mean of registers [Σᵢ₌₁^{m}2^{-M[j]}].

For each snapshot, physical block numbers are hashed in HLL to produce hash values. The hash values are divided into a prefix p and a suffix q. p is used as an index to an array of registers (e.g., buckets). In some embodiments, 64-bit hashes can be used.

HLL is a probabilistic data structure that counts the number of leading zeros. HLL uses hash functions to randomize and represent the data in a compact manner. For instance, if a hash function outputs random bits, then the probability of getting k leading zeros is approximately 2^{-k}. Approximately 32 items would be processed in a case of 5 leading zeros and approximately 1024 items would be processed in a case of 10 leading zeros. Thus, if the quantity of leading zeros is k, then approximately 2^{k} items would be processed. In order to store N items, a data sketch (e.g., a single number) that is log N in size is stored. In order to store a single number that is log N in size, a log(log N) quantity of bits are used, hence the name LogLog. The size of HLL is relatively small and can be stored in memory having 4 KB blocks.

FIG. 3 illustrates an example of HyperLogLog according to one or more embodiments of the present disclosure. Stated differently, FIG. 3 illustrates an example of how HLL can be used to determine cardinality estimates. As shown, FIG. 3 includes four registers 318 with different cardinality. In the example illustrated in FIG. 3, αₘ is 0.56806. Cardinality is estimated based on the formula E=αₘ*m²*Z. E is (0.56806*4*4)/(½)²+(½)²+(½)⁵+(½)=8.81˜8, which is close to the actual value of 7. The bits used to indicate cardinality are underlined in each of the registers 318. Register 318-1 has a cardinality of 2, register 318-2 has a cardinality of 2, register 318-3 has a cardinality of 5, and register 318-4 has a cardinality of 1.

In some embodiments, HLL++ can be used in lieu of HLL. If the snapshot is considered as a set, and the quantity of blocks in a snapshot is considered to be its member, then the cardinality of a set will indicate the quantity of blocks. Thus, cardinality can be used to determine a total number of blocks in a snapshot. There is one HLL (data sketch) for each snapshot. As a result, data sketches representing two snapshots will have the same hash values for blocks that are shared between snapshots. In some embodiments, unions of two data sketches can be determined (e.g., HLL of two snapshots can be merged) to get a total number of blocks in both the snapshots. While set intersection may not be directly supported by HLL, it can be derived by using the inclusion-exclusion principle, discussed further below and symbolically expressed as |A∩B|=|A|+|B|−|A∪B|. A respective data sketch for each snapshot can reside in memory in association with its snapshot and can be used to answer complex space queries.

Embodiments of the present disclosure support deletion of physical block numbers. For instance, there is an in-memory data sketch for each live sub-volume that tracks all the physical block numbers which are newly allocated, and also the ones which are no longer referenced (e.g., deleted or overwritten). This in-memory data sketch is persisted along with the snapshot when a snapshot is created, so each snapshot has a respective data sketch that represents the data stored in the snapshot. This data sketch may be identical or different for two snapshots, depending on whether the physical blocks therein are shared between snapshots or exclusive to one snapshot. In cases where a snapshot is deleted, previous approaches for space reporting would need to adjust their counter(s). In contrast, embodiments herein can determine the physical capacity by determining the cardinality of a data sketch and multiplying it by the size of the block (e.g., 4 kilobytes).

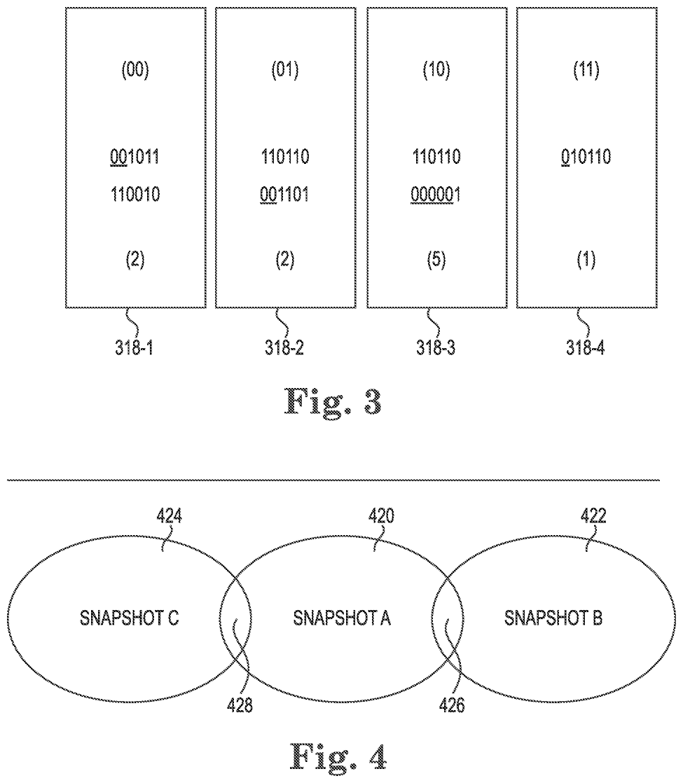

FIG. 4 is a Venn diagram illustrating the physical space represented by three snapshots according to one or more embodiments of the present disclosure. As shown in FIG. 4, the Venn diagram includes snapshot A 420, snapshot B 422, and snapshot C 424. It is noted that while three snapshots are shown in FIG. 4, embodiments of the present disclosure are not limited to a particular quantity of snapshots.

In order to determine the capacity of snapshots using a data sketch, different operations may be performed. AddBlockToSketch adds a physical block number to a data sketch. DeleteBlockFromSketch deletes a physical block number from a data sketch. ComputeCapacity reports shared and exclusive ownership of blocks in a particular snapshot (e.g., snapshot A 420), and the result will indicate the cardinality of shared blocks by comparing the blocks of the snapshot with those of its neighboring snapshots (e.g., snapshot B 422 and/or snapshot C 424). ComputeSimilarity reports the similarity of two snapshots in terms of percentage (discussed further below). ComputeCapacityOfBatch reports shared and exclusive ownership of blocks belonging to a group of the snapshot. The group's physical space can be compared against other snapshots and the live sub-volume.

The capacity can be determined based on the cardinality of the data sketch, and the cardinality of the union of two or more data sketches. Since blocks can be added to the data sketch, cardinality describes the total number of blocks belonging to a data sketch, represented as a set as shown in FIG. 4. As described herein, snapshot space reporting includes reporting of shared storage and exclusive storage between snapshots. A data sketch can be represented by a set, wherein snapshot A 420 is set A, snapshot B 422 is set B, snapshot C 424 is set C, the shared storage between snapshot A 420 and snapshot B 422 is represented by the intersection of set A and set B (e.g., intersection 426), and the shared storage between snapshot A 420 and snapshot C 424 is represented by the intersection of set A and set B (e.g., intersection 428). In some embodiments, shared and exclusive ownership of space can be determined by the inclusion-exclusion rule. In some embodiments, shared and exclusive ownership of space can be determined by using a Jaccard index.

Using the inclusion-exclusion rule, because HLL supports union operation, shared data between two snapshots can be determined by computing the cardinality of set A, the cardinality of set B, and the cardinality of a set A union set B, represented by: |A∩B|=|A|+|B|−|A∪B|. A given snapshot may share some space from previous snapshot, and/or a next snapshot. Accordingly, shared space by snapshot A can be expressed by determining the cardinality of the following relations:
shared blocks with previous snapshot: |A∩C|;
shared blocks with next snapshot: |A∩B|;
shared blocks between previous and next snapshot: |B∩C|; and
shared blocks between current snapshot, previous snapshot, and next snapshot: |A∩B∩C|.

Determining the exclusive physical space of a particular snapshot (e.g., snapshot A), where B and C are neighboring snapshots, can include determining the cardinality of:

1. |A|−|A∩B|

2. |A|−|A∩C|

3. |B∩C|.

Similarity (e.g., shared data blocks) between two snapshots, snapshot A and snapshot B, can be determined by computing Jaccard similarity index (sometimes referred to as the Jaccard similarity coefficient). The Jaccard similarity index compares members for two sets to determine which members are shared and which are distinct. Stated differently, the Jaccard similarity index is a measure of similarity for two sets of data, with a range from 0% to 100%. In some embodiments, the Jaccard similarity index can be used to calculate the similarity of two snapshots residing on the same node and is based on the formula: J(A, B)=|A∩B|/|A∪B=(|A|+|A∪B|)/|A∪B|.

The similarity between snapshot residing on different machines (e.g., a local machine and a remote machine) can be determined if data sketches use hashing based on the content of data blocks, such as a SHA-2 hash, for instance. Then, the Jaccard similarity coefficient can be used to calculate the similarity of snapshots on two different nodes or snapshots that are not related to, or not belonging to, a same file share.

Snapshot space reporting can be used to perform a number of file system functions. In a software defined data center, storage quotas and/or chargeback may be implemented. Storage quotas can be used to constrain the ability of groups and/or individual users within an organization of consuming storage resources. Chargeback involves determining resource (e.g., storage resource) utilization and calculating the corresponding operational cost in order to bill for the services provided. In some embodiments, performing a file system function includes setting a storage quota by reference to the space report. A quota can be set on a user. A quota can be set on a group. Embodiments herein can be deployed to track data usage by a particular group to enforce a group quota across shares. In some embodiments, a notifications can be provided if a user or group is approaching a storage quota. The user or group can adjust their usage and/or usage agreement.

In some embodiments, performing a file system function includes determining a chargeback amount by reference to the space report. Because embodiments herein enable space reporting of snapshots in a shared storage setup more accurately and less expensively than previous approaches, the utilization of storage resources for individuals and/or groups can be better determined. As a result, charge(s) for the storage provided can be more accurately and clearly billed.

In some embodiments, performing a file system function includes providing a duration estimation associated with a replication of a snapshot at a remote location. For instance, snapshot space reporting can be used as an estimator for replication. Solutions based on snapshots (e.g., SnapMirror) utilize an estimate to know how long it will take for a local snapshot to be replicated over to a remote site. Previous approaches of calculating the amount of data for replication may involve performing a snapshot differ (e.g., diff), which involves traversing the B-trees of the snapshot to determine what has changed. In contrast, a data sketch in accordance with the present disclosure involves determining the similarity of snapshots (e.g., via Jaccard Index, discussed above), which can be used to determine the amount of data to be transferred.

Additionally, embodiments herein allow for improved space management tools. VDFS is a distributed filesystem, thus having snapshots across file shares would require aggregation of space usage across file shares. An HLL-based data sketch in accordance with the present disclosure determines the space usage of different snapshots across file shares. This enables a storage administrator, for instance, to better manage space in a snapshot environment.

FIG. 5 is a diagram of a system 514 for snapshot space reporting according to one or more embodiments of the present disclosure. The system 514 can include a database 530 and/or a number of engines, for example first data structure engine 532, second data structure engine 534, space report engine 536, and/or file system function engine 538, and can be in communication with the database 530 via a communication link. The system 514 can include additional or fewer engines than illustrated to perform the various functions described herein. The system can represent program instructions and/or hardware of a machine (e.g., machine 640 as referenced in FIG. 6, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the first data structure engine 532 can include a combination of hardware and program instructions that is configured to create a first probabilistic data structure for a first snapshot of a VCI in a file system based on a hash of physical block numbers of a plurality of blocks of the first snapshot. In some embodiments, the second data structure engine 534 can include a combination of hardware and program instructions that is configured to create a second probabilistic data structure for a second snapshot of the VCI based on a hash of physical block numbers of a plurality of blocks of the second snapshot. In some embodiments, the space report engine 536 can include a combination of hardware and program instructions that is configured to determine a space report for the first and second snapshots based on the first probabilistic data structure and the second probabilistic data structure. In some embodiments, the file system function engine 538 can include a combination of hardware and program instructions that is configured to perform a file system function by reference to the space report.

FIG. 6 is a diagram of a machine for snapshot space reporting according to one or more embodiments of the present disclosure. The machine 640 can utilize software, hardware, firmware, and/or logic to perform a number of functions. The machine 640 can be a combination of hardware and program instructions configured to perform a number of functions (e.g., actions). The hardware, for example, can include a number of processing resources 608 and a number of memory resources 610, such as a machine-readable medium (MRM) or other memory resources 610. The memory resources 610 can be internal and/or external to the machine 640 (e.g., the machine 640 can include internal memory resources and have access to external memory resources). In some embodiments, the machine 640 can be a VCI. The program instructions (e.g., machine-readable instructions (MM)) can include instructions stored on the MRM to implement a particular function (e.g., an action such as creating a first probabilistic data structure). The set of MRI can be executable by one or more of the processing resources 608. The memory resources 610 can be coupled to the machine 640 in a wired and/or wireless manner. For example, the memory resources 610 can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources 610 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 608 can be coupled to the memory resources 610 via a communication path 642. The communication path 642 can be local or remote to the machine 640. Examples of a local communication path 642 can include an electronic bus internal to a machine, where the memory resources 610 are in communication with the processing resources 608 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 642 can be such that the memory resources 610 are remote from the processing resources 608, such as in a network connection between the memory resources 610 and the processing resources 608. That is, the communication path 642 can be a network connection. Examples of such a network connection can include a local area network (LAN), wide area network (WAN), personal area network (PAN), and the Internet, among others.

As shown in FIG. 6, the MM stored in the memory resources 610 can be segmented into a number of modules 632, 634, 636, 638 that when executed by the processing resources 608 can perform a number of functions. As used herein a module includes a set of instructions included to perform a particular task or action. The number of modules 632, 634, 636, 638 can be sub-modules of other modules. For example, the second data structure module 634 can be a sub-module of the first data structure module 632 and/or can be contained within a single module. Furthermore, the number of modules 632, 634, 636, 638 can comprise individual modules separate and distinct from one another. Examples are not limited to the specific modules 632, 634, 636, 638 illustrated in FIG. 6.

Each of the number of modules 632, 634, 636, 638 can include program instructions and/or a combination of hardware and program instructions that, when executed by a processing resource 608, can function as a corresponding engine as described with respect to FIG. 5. For example, the file system function module 638 can include program instructions and/or a combination of hardware and program instructions that, when executed by a processing resource 608, can function as the file system function engine 538, though embodiments of the present disclosure are not so limited.

The machine 640 can include a first data structure module 632, which can include instructions to create a first probabilistic data structure for a first snapshot of a VCI in a file system based on a hash of physical block numbers of a plurality of blocks of the first snapshot. The machine 640 can include a second data structure module 634, which can include instructions to create a second probabilistic data structure for a second snapshot of the VCI based on a hash of physical block numbers of a plurality of blocks of the second snapshot. The machine 640 can include a space report module 636, which can include instructions to determine a space report for the first and second snapshots based on the first probabilistic data structure and the second probabilistic data structure. The machine 640 can include a file system function module, which can include instructions to perform a file system function by reference to the space report.

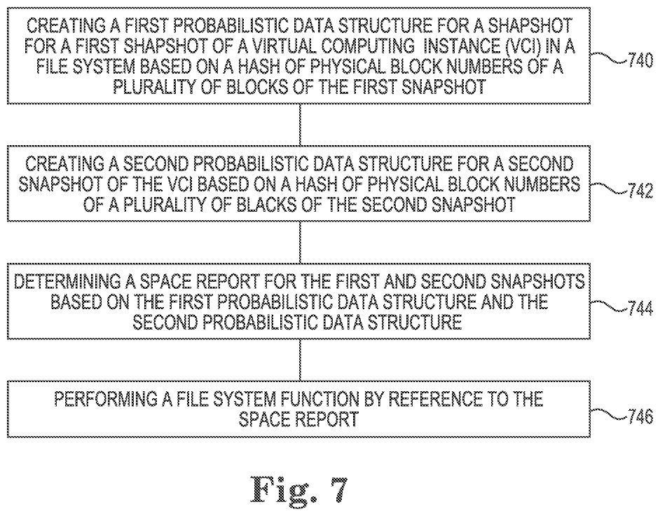

FIG. 7 is a flow chart illustrating one or more methods for snapshot space reporting according to one or more embodiments of the present disclosure. The method can include, at 740, creating a first probabilistic data structure for a first snapshot of a VCI in a file system based on a hash of physical block numbers of a plurality of blocks of the first snapshot. The method can include, at 742, creating a second probabilistic data structure for a second snapshot of the VCI based on a hash of physical block numbers of a plurality of blocks of the second snapshot. The method can include, at 744, determining a space report for the first and second snapshots based on the first probabilistic data structure and the second probabilistic data structure, wherein the space report is indicative of the storage space occupied by the first and second snapshots. In some embodiments, determining the space report includes determining a Jaccard similarity index for the first snapshot and the second snapshot. In some embodiments, determining the space report includes determining a quantity of blocks exclusive to the first snapshot, determining a quantity of blocks exclusive to the second snapshot, and determining a quantity of blocks common to the first snapshot and the second snapshot. Determining the quantity of blocks common to the first snapshot and the second snapshot can include determining a cardinality of the plurality of blocks of the first snapshot, determining a cardinality of the plurality of blocks of the second snapshot, and determining a cardinality of a union of the plurality of blocks of the first snapshot and the plurality of blocks of the second snapshot.

The method can include, at 746, performing a file system function by reference to the space report. In some embodiments, performing the file system function includes setting a storage quota by reference to the space report. In some embodiments, performing the file system function includes providing a duration estimation associated with a replication of either the first snapshot or the second snapshot at a remote location. Although not specifically shown in FIG. 7, the method can include storing the first probabilistic data structure in association with the first snapshot and storing the second probabilistic data structure in association with the second snapshot.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
creating a first probabilistic data structure for a first snapshot of a virtual computing instance (VCI) in a file system based on a hash of physical block numbers of a plurality of blocks of the first snapshot;
creating a second probabilistic data structure for a second snapshot of the VCI based on a hash of physical block numbers of a plurality of blocks of the second snapshot;
determining a space report for the first and second snapshots based on the first probabilistic data structure and the second probabilistic data structure, wherein the space report is indicative of the storage space occupied by the first and second snapshots; and
performing a file system function by reference to the space report.

2. The method of claim 1, wherein determining the space report for the first and second snapshots includes:
determining a cardinality of blocks exclusive to the first snapshot;
determining a cardinality of blocks exclusive to the second snapshot; and
determining a cardinality of blocks common to the first snapshot and the second snapshot.

3. The method of claim 2, wherein determining the quantity of blocks common to the first snapshot and the second snapshot includes:
determining a cardinality of the plurality of blocks of the first snapshot;
determining a cardinality of the plurality of blocks of the second snapshot; and
determining a cardinality of a union of the plurality of blocks of the first snapshot and the plurality of blocks of the second snapshot.

4. The method of claim 1, wherein determining the space report for the first and second snapshots includes determining a Jaccard similarity index for the first snapshot and the second snapshot.

5. The method of claim 1, wherein the method includes storing the first probabilistic data structure in association with the first snapshot and storing the second probabilistic data structure in association with the second snapshot.

6. The method of claim 1, wherein performing the file system function includes setting a storage quota by reference to the space report.

7. The method of claim 1, wherein performing the file system function includes providing an estimation of how long it would take to replicate either the first snapshot or the second snapshot to a remote location.

8. A non-transitory machine-readable medium having instructions stored thereon which, when executed by a processor, cause the processor to:
create a first probabilistic data structure for a first snapshot of a virtual computing instance (VCI) in a file system based on a hash of physical block numbers of a plurality of blocks of the first snapshot;
create a second probabilistic data structure for a second snapshot of the VCI based on a hash of physical block numbers of a plurality of blocks of the second snapshot;
determine a space report for the first and second snapshots based on the first probabilistic data structure and the second probabilistic data structure, wherein the space report is indicative of the storage space occupied by the first and second snapshots; and
perform a file system function by reference to the space report.

9. The medium of claim 1, wherein the instructions to determine the space report for the first and second snapshots include instructions to:
determine a cardinality of blocks exclusive to the first snapshot;
determine a cardinality of blocks exclusive to the second snapshot; and
determine a cardinality of blocks common to the first snapshot and the second snapshot.

10. The medium of claim 9, wherein the instructions to determine the quantity of blocks common to the first snapshot and the second snapshot include instructions to:
determine a cardinality of the plurality of blocks of the first snapshot;
determine a cardinality of the plurality of blocks of the second snapshot; and
determine a cardinality of a union of the plurality of blocks of the first snapshot and the plurality of blocks of the second snapshot.

11. The medium of claim 8, wherein the instructions to determine the space report for the first and second snapshots include instructions to determine a Jaccard similarity index for the first snapshot and the second snapshot.

12. The medium of claim 8, including instructions to store the first probabilistic data structure in association with the first snapshot and storing the second probabilistic data structure in association with the second snapshot.

13. The medium of claim 8, wherein the instructions to perform the file system function include instructions to set a storage quota by reference to the space report.

14. The medium of claim 8, wherein the instructions to perform the file system function include instructions to provide an estimation of how long it would take to replicate either the first snapshot or the second snapshot to a remote location.

15. A system, comprising:
a first data structure engine configured to create a first probabilistic data structure for a first snapshot of a virtual computing instance (VCI) in a file system based on a hash of physical block numbers of a plurality of blocks of the first snapshot;
a second data structure engine configured to create a second probabilistic data structure for a second snapshot of the VCI based on a hash of physical block numbers of a plurality of blocks of the second snapshot;
a space report engine configured to determine a space report for the first and second snapshots based on the first probabilistic data structure and the second probabilistic data structure, wherein the space report is indicative of the storage space occupied by the first and second snapshots; and
a file system function engine configured to perform a file system function by reference to the space report.

16. The system of claim 14, wherein the space report engine is configured to:
determine a cardinality of blocks exclusive to the first snapshot;
determine a cardinality of blocks exclusive to the second snapshot; and
determine a cardinality of blocks common to the first snapshot and the second snapshot.

17. The system of claim 16, wherein the space report engine is configured to:
determine a cardinality of the plurality of blocks of the first snapshot;
determine a cardinality of the plurality of blocks of the second snapshot; and
determine a cardinality of a union of the plurality of blocks of the first snapshot and the plurality of blocks of the second snapshot.

18. The system of claim 14, wherein the space report engine is configured to determine a Jaccard similarity index for the first snapshot and the second snapshot.

19. The system of claim 14, wherein the first data structure engine is configured to store the first probabilistic data structure in association with the first snapshot, and wherein the second data structure engine is configured to store the second probabilistic data structure in association with the second snapshot.

20. The system of claim 14, wherein the file system function engine is configured to provide an estimation of how long it would take to replicate either the first snapshot or the second snapshot to a remote location.
